(19) United States
(12) Patent Application Publication
(10) Pub. No.: US 2006/0146691 A1
(43) Pub. Date: Jul. 6, 2006

(54) Amplitude controller

(76) Inventor: Eero Koukkari, Oulu (FI)

Correspondence Address: YOUNG & THOMPSON, 745 SOUTH 23RD STREET, 2ND FLOOR, ARLINGTON, VA, 22202, US

(21) Appl. No.: 10/561,806

(22) PCT Filed: Jun. 21, 2004
(86) PCT No.: PCT/FI04/00378

§ 371 Date: Dec. 21, 2005

(30) Foreign Application Priority Data
Jun. 24, 2003 (FI) 20030934

(51) Int. Cl. H04J 11/00

(52) U.S. Cl. 370/206

(57) ABSTRACT

An amplitude controller for adjusting the amplitude of a radio-frequency signal, the amplitude controller includes elements for splitting (302A) an amplitude adjustment input signal into one or more signal pairs, each signal pair having two partial signals, elements for generating (302B) an inverse-phase-sized phase difference between the partial signals of each signal pair, elements for adjusting (302C, 302D, 302F) the amplitudes of the partial signals of each signal pair by employing the mutual magnitude of the amplitudes of the partial signals as the factor controlling the adjustment, and elements for summing up (302E) the partial inverse-phased and amplitude-adjusted signals as an output signal.

### FIELD

The invention relates to a method and an apparatus for varying the amplitude of a radio-frequency signal.

### BACKGROUND

Amplitude and phase controllers for a radio-frequency signal are required in RF devices for instance in signal summing circuits, adjustable antennas and modulators. A prior art solution is disclosed in published U.S. Pat. No. 5,392,009.

In the publication, amplitude controllers are implemented with a 90-degree splitter and PIN diodes. When the impedances of the diodes are adjusted to 50 ohm, the entire input power goes to the diodes, which corresponds to the midpoint of an IQ coordinate system. When the impedance starts to be increased upwards from 50 ohm, part of the power starts to go through the amplitude controller and, as the impedance increases to infinity, all power goes to the output of the amplitude controller, the position in the IQ coordinate system being at the right edge of the circle. If the impedance of the diodes is reduced from 50 ohm, part of the power starts to go through the amplitude controller in inverse phase as compared with the input signal, corresponding to the increase of the signal vector on the negative half of the I-axis. The left edge of the IQ circle is reached when the diode impedance is 0 ohm.

The drawback in the prior art solution is that any deviations of the diodes employed as resistors from the characteristic resistance shift the midpoint of the IQ coordinate system. Small deviations are common, resulting for instance from a variation in the diode resistance as a function of temperature or from differences in manufacturing batches of the diodes. The solution according to the cited publication is sensitive to deviations in the resistance of the resistors, since the adjustment depends on absolute values of the resistors, whereby errors caused by the resistors directly change over to adjustment errors.

### BRIEF DESCRIPTION

The object of the invention is to provide an improved method and apparatus for amplitude adjustment in a vector controller. This is achieved by a method of adjusting the amplitude of a radio-frequency signal. The method comprises splitting an input signal received at amplitude adjustment into one or more signal pairs, each signal pair comprising two partial signals having an equal amplitude, generating an inverse-phase-sized phase difference between the partial signals of each signal pair, adjusting the amplitudes of the partial signals of each signal pair by employing the mutual magnitude of the amplitudes of the partial signals as the factor controlling the adjustment, and summing up the amplitude-adjusted partial signals as an output signal.

The invention also relates to a method of adjusting the amplitude of a radio-frequency signal. The method comprises splitting an input signal received at amplitude adjustment into one or more signal pairs, and splitting the input signal of a signal pair into two partial signals in a weighted manner, generating an inverse-phase-sized phase difference between the partial signals of each signal pair, adjusting the amplitudes of the partial signals of each signal pair by employing the mutual magnitude of the amplitudes of the partial signals as the factor controlling the adjustment, and summing up the partial amplitude-adjusted signals as an output signal.

The invention also relates to an amplitude controller for adjusting the amplitude of a radio-frequency signal. The amplitude controller comprises means for splitting an input signal at amplitude adjustment into one or more signal pairs, each signal pair comprising two partial signals, means for generating an inverse-phase-sized phase difference between the partial signals of each signal pair, means for adjusting the amplitudes of the partial signals of each signal pair by employing the mutual magnitude of the amplitudes of the partial signals as the factor controlling the adjustment, and means for summing up the partial inverse-phased and amplitude-adjusted signals as an output signal.

The method of the invention relates to amplitude adjustment in a vector controller. In the context of the description of the invention, amplitude refers to the adjustment of the length of a signal vector in the direction of the I and/or Q axis of an IQ coordinate system. Thus, when the amplitude value changes sign between positive and negative, the phase angle also changes 180 degrees, i.e. in conjunction with the description of the invention, in said special case, amplitude adjustment can also be employed for phase adjustment.

In the solution of the invention, input signal power, such as the power of the I signal component, is split into one or more partial signal pairs. Each partial signal pair comprises two partial signals, for which an inverse-phase-sized phase difference is generated, the inverse-phased partial signals being subjected to amplitude adjustment. The amplitudes of the partial signals are adjusted such that the mutual magnitude of the amplitudes of the partial signals is used as the controlling factor in the adjustment. In an embodiment, the mutual magnitude of the amplitudes is adjusted by adjusting the mutual ratio between the amplitudes of the partial signals. The mutual magnitude can also be adjusted for instance by controlling the amplitudes of the partial signals by equal inverse controls. The amplitudes of the partial signals are adjusted by adjustment means, such as adjustable resistors, for example. The adjustment means, and thus, the amplitudes, can be adjusted for instance by adjusting the amplitudes inversely, i.e. in opposite directions relative to each other. This means that as the resistance of a first adjustment means, such as an adjustable resistor, for example, increases, the resistance of a second adjustable resistor decreases. The resistors are controllable for instance such that the geometrical average of the resistors remains constant. In an embodiment, amplitudes are adjusted by mutually separate controls. The amplitude-adjusted partial signals are summed up as a sum signal, for which the desired amplitude can be obtained with high accuracy. In a solution, the input signal is split at the input end in a weighted manner, i.e. the amplitudes of the partial signals are thus different at the partial signal split point, and the input power is not evenly split between the partial signals.

In the hardware solution of the invention that implements the method, a Wilkinson power splitter, for example can be employed as the power splitter in generating the partial signals. In an embodiment, power splitting and, simultaneously, also the inverse phase difference for the partial signals are implemented by means of a transformer structure. The phase difference can also be implemented by various transmission line or amplifier solutions.

In the hardware solution implementing the invention, the amplitudes of the partial signals can be adjusted for instance with adjustable resistors, the ratio of whose resistances is adjusted as desired, such as inversely relative to each other in respect of the initial values. In an embodiment, adjustable resistors are implemented as a dual diode structure, the same diode package containing two diodes, each of which is intended for adjusting one partial signal of the signal pair. This achieves the advantage that, due to similar manufacturing circumstances and usage conditions, the resistance deviations of the diodes are minimal. The geometric average of the resistances of the adjustable resistors may be constant, for example 50 or 100 ohm.

The simplest way to sum up the partial signals is to combine the partial signal branches, whereby the partial signals are summed up with each other. A separate coupler can also be employed as the coupling means.

The amplitude controller of the invention can be employed for instance in a vector modulator, which is suitable for instance for implementing the amplitude and/or phase management of different amplifier branches in the summing of power amplifiers. The amplitude controller of the invention can also be employed for instance in an electrically controllable antenna comprising two elements in the same antenna. The amplitude and phase of the signals passing to the elements are adjusted in order to enable the variation of the directional pattern of a signal summing up in the air, allowing for instance the main beam to be directed by adjusting the vector controller of the second amplifier. The above-described examples of uses of an amplitude controller are brought forth only by way of illustration, and the invention is not restricted to said applications, but the method and amplitude controller according to the invention can be applied in a very versatile manner to solutions requiring the adjustment of the amplitude of a radio-frequent signal.

A significant advantage over prior art is achieved with the invention in that the inventive solution tolerates markedly well any resistance deviation in the adjustable resistors, such as a deviation due to temperature, for example. In the invention, the amplitude of the output signal depends on the mutual ratio of the resistances of the adjustable resistors, not on their absolute values. As a result is obtained an optimal output signal that is accurately adjustable.

### LIST OF THE FIGURES

In the following, the invention will be described in more detail in connection with preferred embodiments with reference to the accompanying drawing, in which

FIG. 1 shows an embodiment of the method,

FIG. 2 illustrates a use of a vector controller,

FIG. 3 shows the basic structure of an IQ modulator,

FIG. 4A illustrates an IQ modulation coordinate system,

FIG. 4B shows a signal before being split into partial signals,

FIG. 4C shows partial signals generated,

FIG. 4D shows amplitude-adjusted partial signals,

FIG. 4E shows a signal after summing up of partial signals,

FIG. 5 shows an embodiment of a hardware solution,

FIG. 6 shows a second embodiment of a hardware solution,

FIG. 7 shows an embodiment of phase difference implementation,

FIG. 8 illustrates a second embodiment of phase difference implementation, and

FIG. 9 shows still another embodiment of a hardware solution.

### DESCRIPTION OF EMBODIMENTS

In the following, the invention will be described by means of some embodiments with reference to the accompanying figures.

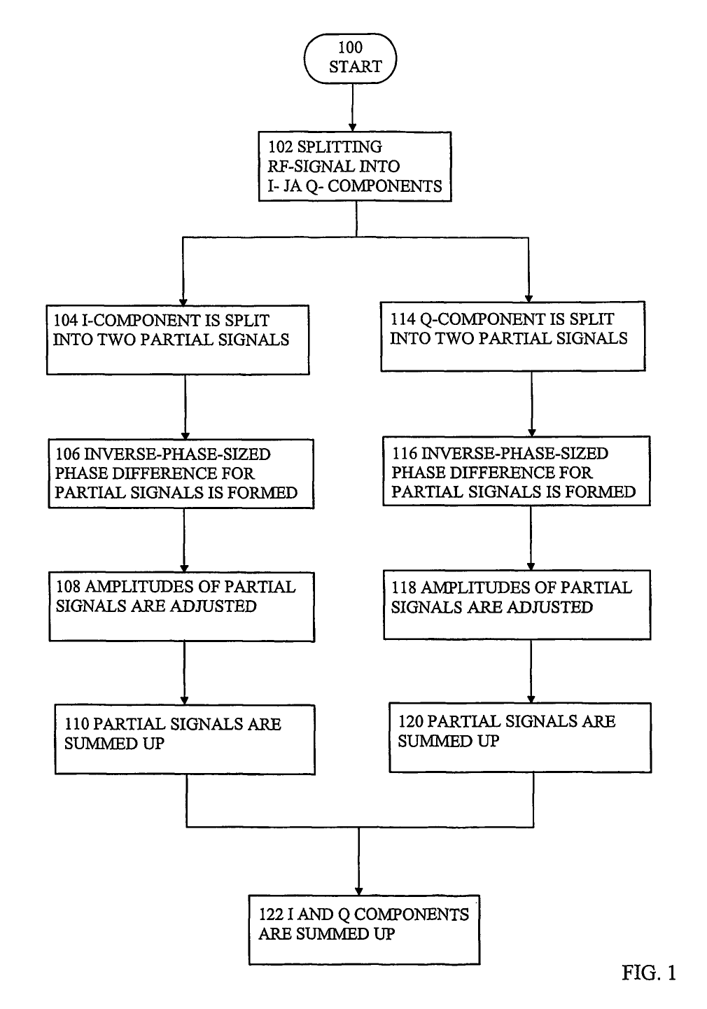

FIG. 1 shows an embodiment of a method. The method starts at step 100, wherein the phase and/or amplitude of a radio-frequency signal are subjected to variation. In method step 102, the radio-frequency signal is split into I and Q components. The I component refers to an in-phase component, and the Q component is a signal, phase-shifted for instance by 90 degrees relative to the I component. From step 102 the process proceeds to steps 104 and 114, wherefrom the I and Q signal components are separately processed. The measures performed on the I signal component are described in more detail by means of steps 104 to 110. The measures performed on the Q component and described by steps 114 to 120 correspond to the steps the I signal is subjected to.

In method step 104, the I signal branch is split into two partial signals. In practice, the splitting into two partial signals can be performed for instance with a Wilkinson power splitter, wherein the input power is equally split among the output ports. In step 106, an inverse-phase-sized phase difference is generated for the partial signals generated in step 104. Between the partial signals, the phase difference can be exactly 180 degrees, but it can also intentionally be shifted to some degree depending on the implementation. Naturally, the phase difference may also deviate to some degree from 180 degrees due to an error caused by the components employed.

In step 108, the amplitudes of the inverse-phased partial signals are adjusted. Amplitude adjustment can be performed by a common control, allowing the ratio of the amplitudes of the partial signals to be adjusted as desired.

It is to be noted that the order of method steps 106 and 108 may deviate from the description of FIG. 1 in a practical implementation. In other words, the solution may also be implemented by first adjusting the amplitudes of the partial signals, followed by generating the desired inverse-phase-sized phase difference in one of the amplitude-adjusted signals, or amplitude and phase difference variations can be performed in several steps and in different orders.

In step 110, the partial signals are summed up as an output signal for amplitude control. In signal summing, the inverse-phased signals attenuate each other, i.e., in practice, a differential signal of the partial signals passes forward from the summing. In step 122, the I and Q signal components are summed up, producing a signal to be transmitted to the radio path.

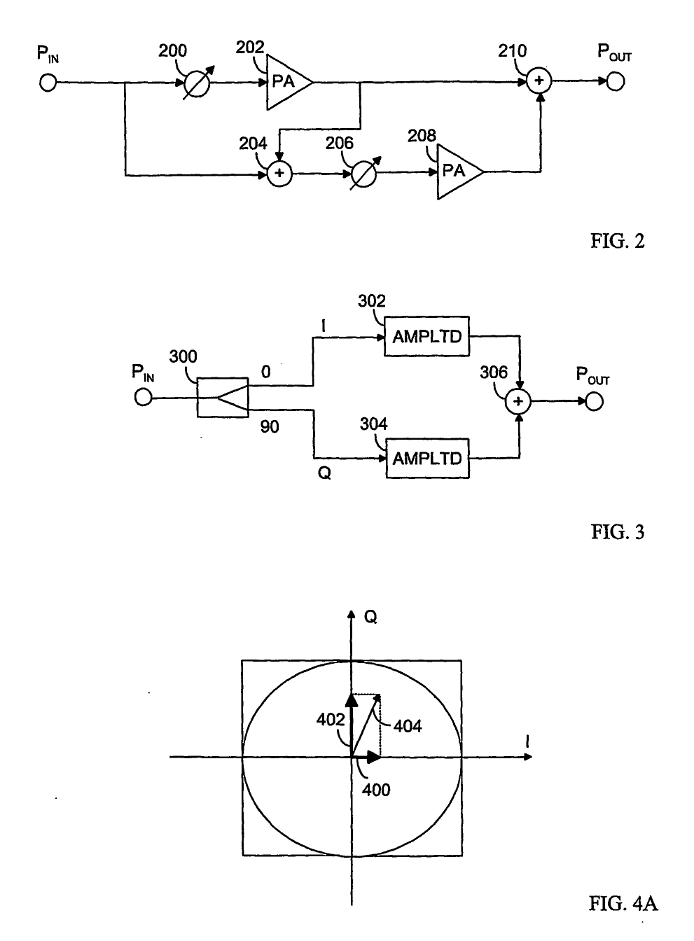

FIG. 2 illustrates a linear amplifier in which the amplitude and phase of a radio-frequency signal are adjusted. The circuit of the figure shows a so-called feedforward amplifier circuit, which serves to remove the distortion of the main amplifier 202, i.e. the error signal generated in the amplification. In the circuit, the input signal P_{IN} is first split into two signal paths, one of which is controlled to a vector controller 200 at the main branch and the other to a coupler 204 at the side branch. Accordingly, a signal amplified with the main amplifier 202 and the original input signal P_{IN} are directed to the coupler 204. The vector controller 200 serves to adjust the amplitude and phase of the main amplifier branch such that the amplitudes of the effective signal components at the inputs of the coupler 204 are equal but inverse-phased. Accordingly, the effective signal is cancelled out in the coupler 204, and only the distortion generated by the main amplifier 202 leaves as the output of the coupler 204. As inputs to the output coupler 210, in turn, are obtained a signal amplified with the main amplifier 202 and the distortion generated by the main amplificatory and obtained as output of the coupler 204. At the distortion amplifier branch, the amplitude and phase of the distortion signal are adjusted with the vector controller 206 such that the amplitudes of the distortion signal components of the main signal branch and the distortion signal branch at the input of the output coupler 210 are equal but inverse-phased. Accordingly, the distortion components at the output coupler 210 are cancelled out, and only the pure signal part P_{OUT} leaving the main amplifier 202 reaches the output of the output coupler 210.

FIG. 3 shows a vector modulator, i.e. a hardware solution for implementing a vector controller enabling amplitude and phase shift. The input signal P_{IN} of the vector controller is first split with a power splitter 300 into two different-phased signal components, of which the I component is non-phase-shifted, i.e. the phase shift is 0 degrees, and the Q component is 90 degrees phase-shifted in the example of FIG. 3. The signal components are directed to their dedicated amplitude controllers 302 and 304, and the amplitude-adjusted signal components are combined in the output coupler 306 for generating the output signal P_{OUT}.

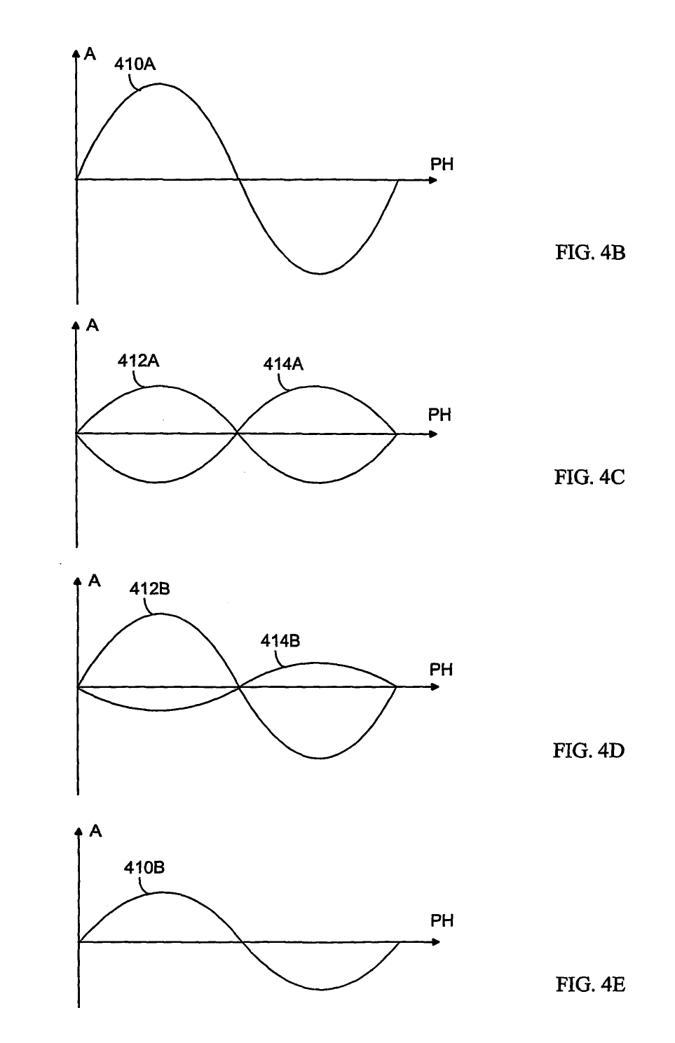

FIG. 4A illustrates, by means of an IQ coordinate system, the variation in signal amplitude and phase. In the IQ coordinate system, signal amplitude is seen by means of the length of the signal vector, the angle indicating the signal phase in respect of the positive I-axis. A vector 400 in the direction of the I-axis of the coordinate system indicates the magnitude of the adjustment of the amplitude controller 302 in FIG. 3. For instance, when the amplitude controller 302 at the I branch is adjusted to its maximum, the signal vector 400 of the I-axis of the coordinate system indicates in the direction of the I-axis up to the periphery of the circle or square. When the signal amplitude adjustment is decreased, i.e. signal attenuation is increased, the vector in the direction of the I-axis shortens and, at its minimum, decreases up to the zero point of the I-axis. When the control is decreased further, the vector in the direction of the I-axis changes directions, whereby the phase angle of the vector is −180 degrees. On the negative side of the I-axis, the amplitude may correspondingly increase to its maximum up to the periphery of the circle or square.

Similarly, the Q signal component 402 can be adjusted with the amplitude controller 304 of FIG. 3 in the direction of the Q axis both on the positive and negative portion of the axis. The I vector 400 and Q vector 402 are summed up in the output coupler 306 of the modulator, and a signal vector 404 is obtained at the output, the vector being inside the square at any phase angle and of any length. However, generally, only the area inside the circle is used for the adjustment.

In FIG. 4B, the function 410 represents a given signal component, such as the I or Q signal component of IQ modulation, for example. In the coordinate system, the x-axis represents signal phase and the y-axis signal amplitude. FIG. 4C depicts a situation wherein the signal component 410A of FIG. 4B is split into two inverse-phased partial signals 412A, 414A. It can be seen that the power of signal component 410A is evenly distributed between the partial signals 412A, 414A.

FIG. 4D illustrates a situation wherein the partial signals 412A and 414A are subjected to amplitude adjustment, yielding partial signals 412B and 414B. The partial signal 412B is amplified in respect of the partial signal 412A, and the partial signal 414B is attenuated in respect of the partial signal 414A, i.e. the partial signals 412B, 414B are adjusted inversely relative to each other. The situation of FIG. 4D could also be reached by amplifying the amplitudes of the partial signals 412A, 414A to be as strong as the original signal component 410A, after which they only have to be subjected to attenuation.

FIG. 4E shows a signal component 410B, which is generated by summing up the partial signals 412B, 414B of FIG. 4D. Accordingly, the maximum amplitude value, which is half the amplitude of the original unadjusted signal 410A shown in FIG. 4B, is reached by separately adjusting the partial signals.

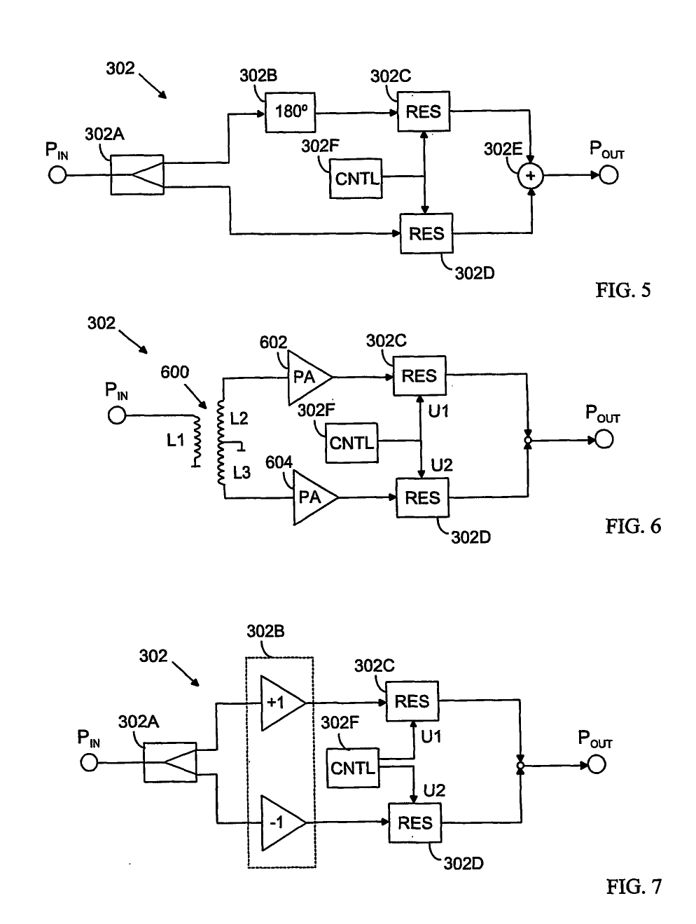

FIG. 5 shows an embodiment of the amplitude controller 302 of FIG. 3. The amplitude controller 304 of FIG. 3 can be implemented in a corresponding manner as the following amplitude controller 302 to be described next in more detail. The input signal P_{IN} of the amplitude controller 302 is split in a power splitter 302A into a signal pair, i.e. two separate and mutually inverse-phased partial signals, i.e. signal branches. Herein, the power splitter 302A is shown as one alternative implementation only. Splitting the input power can also be implemented without a power splitter by directly splitting the signal line into two branches, whereby the signal power is split into two parts. There may be more partial signal pairs than the one pair shown in FIG. 5, however, such that each partial signal pair comprises two inverse-phased partial signals. The power splitter 302A employed is for instance a Wilkinson power splitter, wherein the input power is equally split between the output signals. In the solution of FIG. 5, the first partial signal is subjected to phase inversion, i.e. an about 180-degree phase inversion with a phase inversion means 302B. Phase inversion can be implemented for instance with an inverting amplifier, a transformer, a λ/2-long transmission line or a strip structure.

The amplitude adjustment means of FIG. 5 comprise a control unit 302F, a first amplitude adjustment means 302C and a second amplitude adjustment means 302D. The first partial signal having passed the phase inversion means 302B is directed to the first amplitude adjustment means 302C, and the second partial signal is directed to the second amplitude adjustment means 302D. The adjustment means 302C, 302D can be for instance adjustable resistors. In the solution of FIG. 5, common control from a control unit 302F is arranged for the adjustment means 302C, 302D. The common control can be used to adjust the ratio of the adjustment of the adjustment means 302C, 302D as desired such that the output P_{OUT} obtained from a coupler 302E is as desired. In an embodiment, instead of common control, the amplitude adjustment means are configured to adjust the amplitudes of the partial signals relative to each other by separate controls from the control unit 302F. In an embodiment, the control can be arranged such that the amplitude adjustment means adjust the amplitudes of the partial signals inversely relative to each other. Although FIG. 5 shows a separate coupler means 302E, in practice, the partial signals can be combined, at the simplest, by combining the partial signal lines.

In an embodiment, the resistances of the adjustment means 302C, 302D are inversely adjusted from being equal such that the resistance of the adjustment means 302C is for instance Z₀*K and the resistance of the adjustment means 302D is Z₀/K, wherein Z₀ is the resistance value with which optimum matching is obtained at the output port of the adjuster, and coefficient K is a variable depicting the attenuation of the adjustment means. The geometrical average of the resistances of the adjustment means 302C, 302D is thus Z₀. Accordingly, the control means 302F are used to control the value of the attenuation variable K. When K has value 1, the partial signals encounter a mutually equally levelled attenuation, when K has value K>1, the upper partial signal is subjected to higher attenuation, and when K has value K<1, the lower partial signal is subjected to higher attenuation. The solution of FIG. 5 achieves the advantage that, in principle, the amplitude of the sum signal generated depends only on the mutual relationship of the adjustable resistors, not on their absolute values. Although it was described in FIG. 5 above that, in the signal branch, phase inversion is placed before amplitude adjustment, the hardware implementation is not restricted thereto, but phase inversion may be anywhere in the partial signal branch, as long as it implements the desired inverse-phase-sized phase difference on the signal between the power split point and the summing point.

FIG. 6 shows a second embodiment of an amplitude controller. The power splitter 302A and phase inversion means 302B of FIG. 5 are implemented as a transformer structure 600 in the solution according to FIG. 6. The transformation ratios of the transformer structure 600 are selected such that the transformation ratios from a primary winding L1 to secondary windings L2 and L3 are equal but provide an inverse signal phase at the inputs of resistors 302C and 302D. If the transformation ratio is one, then the input and output impedances are equal, a preferred adjustable resistor impedance at the first branch is Z₀*K and at the second Z₀/K, wherein K is a variable depicting the attenuation of the adjuster means. In the above, the case K>1 depicts positive axis parts of the IQ coordinate system and the case K<1 negative axis parts of the coordinate system, wherein the signals representing the different axis parts are at a 180-degree phase shift relative to each other. The value K=1 is at the midpoint of the coordinate system, the attenuation being infinite. FIG. 6 also shows power amplifiers 602, 604 at the partial signal branches, which can be used to raise the power level of the partial signals to the desired level before the attenuation performed with the adjustable resistors 302C, 302D.

FIG. 7 shows still another embodiment of the amplitude controller 302B. In the solution of FIG. 7, the desired 180-degree phase inversion is implemented as a phase inversion means 302B comprising two inverse amplifiers. FIG. 7 also shows how the adjustable resistors 302C and 302D are controlled by different controls from the control unit 302F.

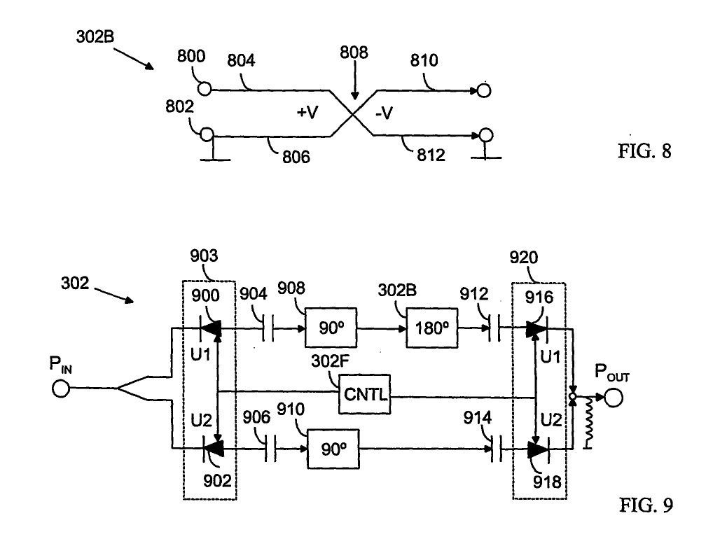

FIG. 8 shows a second embodiment for implementing the phase inversion means 302B. Phase inversion can be implemented by a λ/4-long symmetric transmission line structure composed of conductors 804 and 806. The conductors 804 and 806 are coupled crosswise in the middle of line 808. The structure of FIG. 8 implements a 180-degree phase inversion as compared with a λ/4 transmission line. For direct current, ports 800, 802 are shorted to the ground because of the middle cross-coupling 808, but as the frequency increases to the centre frequency of the transmission line, the mismatch effect of the cross-coupling 808 totally disappears by suitable dimensioning of the structure. In addition, in the environment of the centre frequency, the λ/4 compensation property cancels out other mismatches due to the cross circuit.

In the implementation of the circuit of FIG. 8, the means employed for generating the phase difference can be a transmission line pair, the first transmission line of the transmission line pair comprising conductors 804, 806 and the second transmission line comprising conductors 810, 812. The conductors of the first transmission line and the second transmission line are cross-coupled at circuit point 808 for generating a 270-degree phase shift for the partial signal.

The solution of FIG. 8 can be implemented by the use of transmission lines arranged on different layers of a circuit board. In the case of a multiple layer circuit board, the first conductor of the transmission line can be kept at the surface layer of the circuit beard, and the second conductor at some other layer. To achieve a symmetrical structure, the conductors of the transmission lines are cross-coupled in the middle of the electric longitudinal axis of the line. To achieve a broader-band implementation, a structure can be employed, wherein the characteristic impedances of the conductors relative to the surrounding ground are as high as possible. In the solution of FIG. 8, strip lines, coaxial cables or other transmission line structures can be used as the transmission lines.

In the circuit of FIG. 9, a signal is asymmetrically split at the input port by controlling both adjustment components of the branch in the same manner. In the embodiment illustrated in FIG. 9, PIN diodes 900, 902, 916 and 918 are employed as adjustable resistors. In the circuit, the attenuation of the amplitude controller is based on the mutual relationship of the resistors at the split points, i.e. in the case of FIG. 9, on the mutual relationship of the resistors 900 and 902 and the mutual relationship of the resistors 916, 918. Accordingly, attenuation is not a function of the absolute resistance value of the adjustable resistors as is in a prior art splitter adjuster, but a function of the mutual relationship of the diodes of the split point, such as 900 and 902. Particularly when dual diodes in the same packages 903, 920 are employed, accurate attenuation characteristics are achieved, since the diodes 900, 902 and diodes 916, 918, respectively, are as similar as possible and they are in the same environmental conditions when being used. During adjustment, the diodes 900 and 916 are controlled in the same way, i.e. a control voltage U₁ of the same magnitude arrives at both from the control unit 302F and, similarly, control voltages U₂ of the same magnitude control the diodes 902 and 918.

In the circuit, a 90-degree (or λ/4-long) phase shift means 908 and 910 is placed at both partial signal branches. The phase shift means 908, 910 serve to cancel out the non-idealities of the adjuster diodes and capacitors of the signal branch. The capacitors 904, 906, 912 and 914 of the circuit are DC decoupling capacitors that decouple the control voltages of the diodes from the rest of the circuit. The phase shift means can be implemented with for instance λ/4-long transmission lines, separate components or composite structures. Since the diodes, such as 900 and 916, of the same branch are at a distance of λ/4+n*λ/2 or 90°+n*180° (n=0, 1, 2, 3, . . . ) from each other, the non-idealities between them, including the internal parasitic reactances of the diodes 900, 916 are cancelled out at the circuit. Similarly, the deviation of the geometric average of the diodes from Z₀ is cancelled out, particularly at low attenuation values.

Although the invention is described above with reference to the example in accordance with the accompanying drawings, it will be appreciated that the invention is not to be so limited, but it may be modified in a variety of ways within the scope of the appended claims.

1-14. (canceled)

15. A method of adjusting the amplitude of a radio-frequency signal, the method comprising:
splitting an input signal received at amplitude adjustment into one or more signal pairs, each signal pair comprising two partial signals having an equal amplitude;
generating an inverse-phase-sized phase difference between the partial signals of each signal pair, by:
adjusting the amplitudes of the partial signals of each signal pair by employing the mutual magnitude of the amplitudes of the partial signals as the factor controlling the adjustment; and
summing up the amplitude-adjusted partial signals as an output signal.

16. A method of adjusting the amplitude of a radio-frequency signal, which comprises:
splitting an input signal received at amplitude adjustment into one or more signal pairs, and splitting the input signal of a signal pair into two partial signals in a weighted manner;
generating an inverse-phase-sized phase difference between the partial signals of each signal pair;
adjusting the amplitudes of the partial signals of each signal pair by employing the mutual magnitude of the amplitudes of the partial signals as the factor controlling the adjustment; and
summing up the partial amplitude-adjusted signals as an output signal.

17. An amplitude controller for adjusting the amplitude of a radio-frequency signal, the amplitude controller comprising:
means for splitting an input signal at amplitude adjustment into one or more signal pairs, each signal pair comprising two partial signals;
means for generating an inverse-phase-sized phase difference between the partial signals of each signal pair, wherein the amplitude controller comprises:
means for adjusting the amplitudes of the partial signals of each signal pair by employing the mutual magnitude of the amplitudes of the partial signals as the factor controlling the adjustment; and
means for summing up the partial inverse-phased and amplitude-adjusted signals as an output signal.

18. An amplitude controller as claimed in claim 17, wherein the amplitude adjustment means comprise a first adjustment means pair comprising an adjustment means for each partial signal of a signal pair, and the amplitude adjustment means comprise a second adjustment means pair comprising an adjustment means for each partial signal, and the adjustment means of the adjustment means pairs are adjusted by mutually inverse controls.

19. An amplitude controller as claimed in claim 17, wherein the signal splitter means are configured to split the signal into two partial signals propagating along different signal paths.

20. An amplitude controller as claimed in claim 17, wherein the amplitude adjustment means comprise at least one adjustable resistor for each partial signal of a signal pair.

21. An amplitude controller as claimed in claim 20, wherein the partial signal is transferred in the amplitude adjuster through an adjustment resistor.

22. An amplitude controller as claimed in claim 17, wherein the input signal splitter means and the phase difference generation means comprise:
a primary winding;
a first secondary winding in inductive connection to an output coil;
a second secondary winding in inductive connection to an output coil; and
the polarities of the first secondary winding and the second secondary winding being inverse for generating inverse-phased partial signals.

23. An amplitude controller as claimed in claim 17, wherein the phase difference generation means comprise a series-coupled transmission line pair having a total length of 90° compared with the wavelength of the signal, the conductors of said transmission line pair being cross-coupled for generating a 270° phase shift for the partial signal.

24. An amplitude controller as claimed in claim 17, wherein the amplitude adjustment means comprise a dual diode, and the dual diode comprises a diode for each partial signal of a signal pair for adjusting the amplitude of the partial signal.

25. An amplitude controller as claimed in claim 17, wherein the phase difference generation means comprise a first amplifier for amplifying a first partial signal and a second amplifier for amplifying a second partial signal, the amplifications of the first amplifier and the second amplifier being mutually inverse.

26. An amplitude controller as claimed in claim 18, wherein the first and second amplitude adjustment means pairs are placed in the partial signal branch at a distance of λ/4+n*λ/2 or 90°+n*180° (n=0, 1, 2, 3, . . . ) from each other for cancelling out the non-idealities of the adjustment means.

27. An amplitude controller as claimed in claim 18, wherein at least one amplitude adjustment means pair is an adjustable resistor pair whose resistors are directly coupled together for splitting a signal into partial signals or for summing up the partial signals as an output signal for the adjuster.

28. An amplitude controller as claimed in claim 18, wherein the adjustment means of the first adjustment means pair and the second adjustment means pair that are directed to the same signal are adjusted by the same control.
